(19) United States
(12) Patent Application Publication
(10) Pub. No.: US 2007/0055985 A1
(43) Pub. Date: Mar. 8, 2007

(54) Ad insertion in switched broadcast network

(75) Inventors: Jay B. Schiller, Denver, CO (US); Joseph R. Matarese, Portland, OR (US); Andrew J.B. Poole, Louisville, CO (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Broadband Royalty Corporation, Wilmington, DE (US)

(21) Appl. No.: 11/217,346

(22) Filed: Sep. 2, 2005

(51) Int. Cl. H04N 7/025; G06F 3/00; G06F 13/00; H04N 7/10; H04N 5/445

(52) U.S. Cl. 725/34; 725/32; 725/35; 725/46

(57) ABSTRACT

A system, such as a switched broadcast content delivery system, may include and/or involve at least one video server, and logic to select one or more ads for streaming by the at least one video server, the one or more ads selected at least in part according to information about which of one or more regional modulators are passing and/or will be passing content with which the one or more ads are associated.

### TECHNICAL FIELD

The present disclosure relates to advertising selection and tracking.

### BACKGROUND

Advertisers have long sought to better understand the audience reached by, a.k.a. exposed to, their ads. In broadcast environments, it is often quite difficult to ascertain who is exposed to an ad. Advertisers have thus resorted to surveys, coupons, specials, and other techniques to better gauge their audience.

In conventional cable systems the program lineup if typically fixed across all services areas. This limits the flexibility that is available when selecting advertising to include with program content.

The advent of new content delivery mechanisms, such as switched broadcast networks, creates new possibilities for tracking ad exposure, and selecting ads appropriate to an audience.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A system, such as a switched broadcast content delivery system includes logic to select content, and may include and/or involve at least one video server, and logic to select one or more ads for streaming by the at least one video server, the one or more ads selected at least in part according to information about which of one or more regional modulators are passing and/or will be passing content with which the one or more ads are associated.

The logic to select one or more ads for streaming by the at least one video server may include and/or involve logic to select one or more ads according to demographic information for one or more geographic areas served by the one or more regional modulators, and/or logic to select one or more ads at least in part according to a number of subscribers in an area or areas served by the one or more regional modulators, and/or logic to select one or more ads at least in part according to one or more characteristics of homes and/or businesses in an area or areas served by the one or more regional modulators, and/or logic to select one or more ads at least in part according to viewer habits for an area or areas served by the regional modulator.

The logic to select one or more ads for streaming by the at least one video server may include and/or involve logic to select one or more ads at least in part according to programming choices and/or video-on-demand purchases for one or more customers of an area or areas by the one or more regional modulators, and/or logic to select one or more ads at least in part according to consumption habits of viewers in an area or areas served by the one or more regional modulators

The logic to select one or more ads for streaming by the at least one video server may include and/or involve logic to select one or more ads at least in part according to one or more ad schedules, and/or logic to select one or more ads at least in part according to ads to which a region or regions served by the one or more digital modulators were previously exposed, and/or logic to select one or more ads according to at least one of a program viewing profile or ad exposure profile for a region or regions served by the one or more regional modulators, and/or logic to skip streaming one or more ads specified by one or more ad schedules, when the information about which regional modulators are passing the content indicates that inadequate ad exposure would result from streaming the ad, and/or logic to select one or more ads in accordance with rules specified in one or more ad schedules.

The logic to select one or more ads at least in part according to one or more characteristics of homes and/or businesses in an area or areas served by the one or more regional modulators may include and/or involve logic to select one or more ads at least in part according to one or more of income levels of households in the area or areas, size and/or age and/or price of homes in the area or areas, age and/or ethnic distribution of residents of the area or areas, or education levels for residents of the area or areas. The logic to select one or more ads at least in part according to viewer habits for an area or areas served by the regional modulator may include and/or involve logic to select one or more ads at least in part according to one or more of viewer program preferences, times when viewers are likely to be viewing, or how often and under what circumstances viewers are likely to switch programs.

The logic to select one or more ads at least in part according to ads to which a region or regions served by the one or more digital modulators were previously exposed may include and/or involve logic to select one or more ads at least in part according to ads previously associated with the content for a region or regions served by the one or more regional modulators, and/or logic to reference one or more ad exposure records for or including a region or regions served by the regional modulators.

A system, such as a switched broadcast network, may include and/or involve logic to update one or more ad exposure records at least in part according to information about which of one or more regional modulators are passing, will be passing, and/or passed content with which the one or more ads are associated.

The system may include and/or involve logic to select one or more ads for streaming by the at least one video server, the one or more ads selected at least in part according to profile information for households receiving content with which the one or more ads are to be associated, the video server streaming the one or more ads to one or more regional modulators serving the households.

The system may include and/or involve logic to select one or more ads to stream at least in part according to characteristics of the content with which to associate the ads. The logic to select one or more ads to stream at least in part according to characteristics of the content with which to associate the ads may include and/or involve logic to select one or more ads at least in part according to at least one of a category, genre, actor, theme, plot, target audience, or other attribute of the content.

The system may include and/or involve logic to select one or more advertisements at least in part according to one or more of a time of day, a day of the week, a season, or a date.

The system may include and/or involve logic to skip recording an ad exposure indication when actual exposure information for the area or areas served by one or more regional modulators is applied to indicate that insufficient exposure resulted for the one or more ads selected for streaming.

The system may include and/or involve recording ad exposure information for the selected one or more ads that includes an indication of a region or regions served by the one or more regional modulators which passed the content with which the one or more ads are associated.

The system may include and/or involve one or more communication interfaces to regional distribution nodes, and logic to select one or more ads for insertion into streamed video content at least in part according to information about which of the regional distribution nodes are and/or will be distributing content into which the one or more regional ads are to be embedded.

The system may include and/or involve logic to record ad exposure information including information indicating which of the regional distribution nodes is distributing, will be distributing, and/or did distribute the content into which the one or more regional ads are to be embedded.

The system may include and/or involve logic to receive from a set top box, in conjunction with a program selection, a set top box identifier, and an identifier of a regional distribution node with which the set top box is associated, and to associate likely viewer information with the regional distribution node and/or the set top box identifier, and to select one or more ads to include with a viewer experience of content selected by the program selection, the ads selected at least in part according to the likely viewer information.

The system may include and/or involve logic to select one or more ads to stream at least in part according to characteristics of the content with which to associate the ads. The logic to select one or more ads to stream at least in part according to characteristics of the content with which to associate the ads may include and/or involve logic to select one or more ads at least in part according to at least one of a category, genre, actor, theme, plot, target audience, or other attribute of the content.

The system may include and/or involve logic to select one or more advertisements at least in part according to one or more of a time of day, a day of the week, a season, or a date.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a system to provide ad selection and tracking.

FIG. 2 is a block diagram of an embodiment of a system to provide ad selection, distribution, and tracking.

FIG. 3 is a block diagram of an embodiment of a system to provide ad selection, distribution, and tracking.

FIG. 4 is a flow chart of an embodiment of a process of content selection and distribution.

FIG. 5 is a flow chart of an embodiment of a process of ad selection.

FIG. 6 is a flow chart of an embodiment of a process of ad tracking.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

### Overview of Digital Program Insertion (DPI)

A subscriber in a region or regions served by one or more splicers, modulators, and/or other equipment of a regional distribution node chooses to watch a program. If no other subscriber in the region(s) is currently watching that program, an application (e.g. a “session manager”) checks whether there's sufficient bandwidth on a local distribution plant to deliver the program content to the subscriber's equipment, and if so, instructs one or more modulators (typically also an RF upconverter), splicers, switches, or other equipment contributing to the regional distribution node to allow that program to stream to the subscriber's equipment. The session manager instructs the subscriber equipment with the RF channel and program number (e.g. MPEG program number) to tune in order to receive the program. If a second or more subscribers choose to view the same program, the session manager instructs their subscriber equipment with the RF channel and program number to tune in order to receive the program.

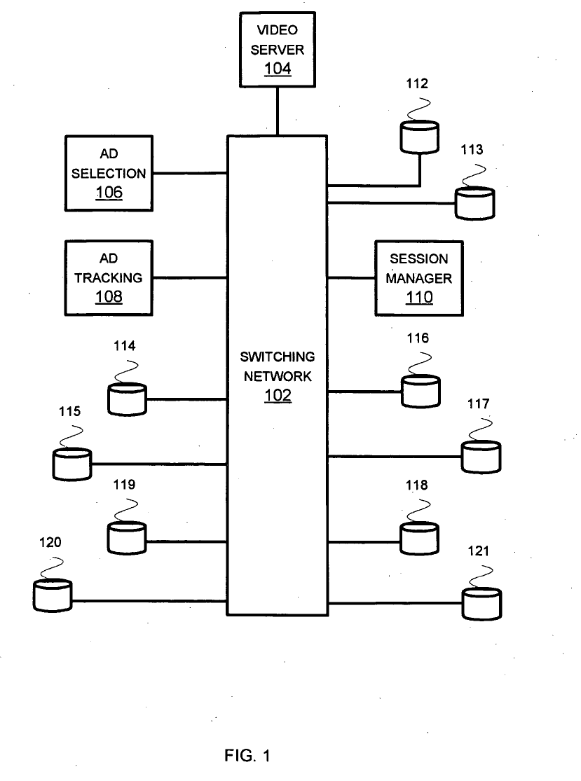

Description of FIG. 1

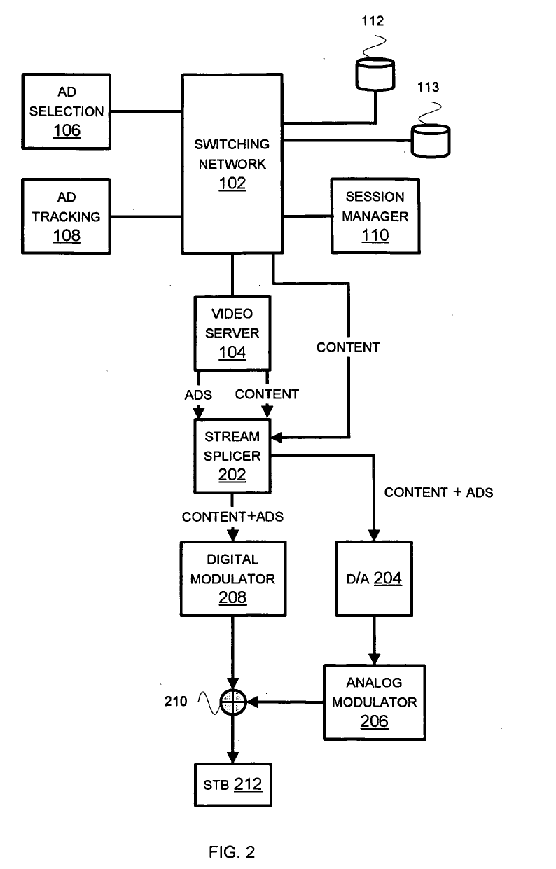

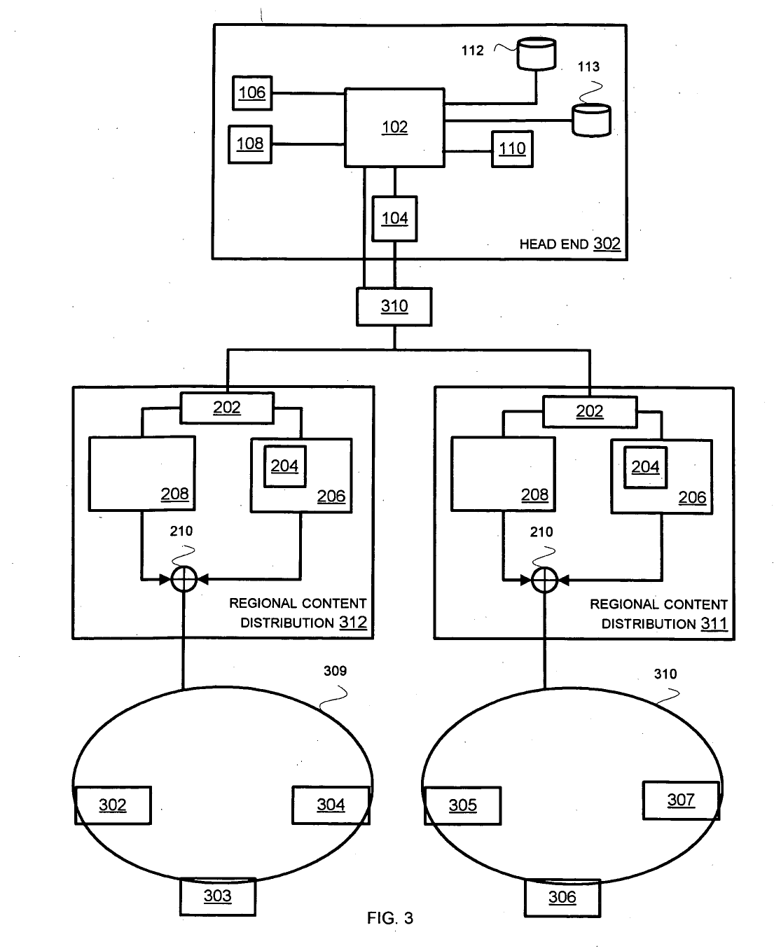

FIG. 1 is a block diagram of an embodiment of a system to provide ad selection and tracking. FIG. 1 includes a description of system components that may be collocated in a headend system in some implementations. FIG. 1 omits other components that may be present in the headend system or may be located “downstream”, e.g. closer to subscriber equipment in the content distribution system. An implementation of a distribution system including exemplary downstream components is illustrated in FIGS. 2-3, including modulators and/or program splicers for providing ad insertion into programming content. In some implementations, one or more of the downstream components illustrated in FIGS. 2-3 may be collocated with and/or comprised by headend systems.

In the description that follows, programming content 112 may be provided from various sources, including satellite broadcasts, upstream headend or control centers (e.g. via optical fiber), and from content storage facilities such as optical disks, magnetic disks, or even tape (e.g. for streaming by the video server in video on demand environments).

A switching network 102 enables communication between various system components. The switching network 102, which may include one or more Gigabit Ethernet switches, optical switches, or other high performance devices, may provide high-speed, high-throughput communications. In some situations, the switching network 102 may include only switching logic and modulators. Although the switching network 102 is shown as a primary mechanism of communication between certain system components, in some situations the various of the system components may communicate using other or additional mechanisms.

The system includes a video server 104, which may stream ad content 113 for insertion into programming content 112. In some situations, such as video on demand, the video server 104 may also stream the programming content 112. In other situations the programming content may be provided from satellite broadcasts, upstream distribution points (e.g. via optical fiber), or via other sources.

Program content 112 may be delivered as a multicast, e.g. as a collection of program streams, over either the switching network 102 or via another distribution system. Endpoint devices, such as set top boxes (STBs) or other subscriber equipment, may tune to a particular program within the multicast. Prior to reaching the endpoint devices, the multicast may be received and processed by regional devices such as modulators, splicers, and/or multiplexers. Regional devices are discussed in more detail at a later point in this description.

Often, program content will include embedded advertising intended to reach the entire audience of the program, and indications, called cues, of locations in the stream where local advertising may be inserted, called local ad breaks. Ad insertion may take place when a cue for a local ad break is detected in a program stream, and the ad selection 106 logic is invoked to select one or more ads to insert at that break. The ad selection logic 106 communicates with the video server 104 to cause content corresponding to the ad to insert to be streamed. Thus, programming content 112 and ad content 113 may both be streamed during local ad breaks, with the ad content “spliced” into the program content at the appropriate times and/or places. Splicing may occur within or collocated with a headend distribution system, or further downstream in the distribution system (see FIGS. 2 and 3).

The ad selector 106 may select zero, one, or multiple ads to insert at the ad break. Ad breaks in program content may be identified in various fashions, including using SCTE 35 cue packets (e.g. with MPEG formatted program content), using digitized DTMF tones, as commonly understood by one skilled in the art, and possibly using other means as well. Often, ad breaks occur near the beginning and end of program content, and sometimes at other times/places as well.

The ad selector 106 may identify ads for inserting by applying one or more ad schedules 115. Ad schedules 115 may provide information such as on what days an ad is to play, at what times or how often during the day the ad is to play, how many ad exposures the ad should receive when played, types of content that the ad should be associated with, a channel or channels the ad should play on, a region or regions that should be exposed to the ad, and so on. At least some of the information included in an ad schedule 115 may represent time slots, program slots, and so on that have been committed to one or more ad time purchasers. In some situations, for some ads, the ad schedule 115 may be inflexible. In other situations, for some ads, the ad schedule 115 may vary and/or adapt over time according to various dynamic factors.

The ad selector 106 may interpret ad metadata 121 during the ad selection process. Ad metadata 121 may include information such as what is being sold and the demographics for the target audience for the ad. For example, ad metadata for an ad for video games may identify the target audience as young men from age eighteen to age twenty-six.

The ad selector 106 may apply ad exposure information 114. The ad exposure information 114 may be derived from an ad log which includes items such as when the ad ran, on what channels, and so forth. It may also include information which could be used to gauge ad effectiveness. Such information may include items such as how many households were in the area(s) receiving the ad and/or which households were tuned to the programs comprising the ad.

The ad selector 106 may access various information sources in order to select ads for insertion into content streams that most effectively satisfy the requirements of the ad time purchasers. The ad selector 106 may apply regional information 120 when selecting ads. For example, a certain number of set top boxes may be served by a regional quadrature amplitude modulator (QAM) that is passing a particular program.

A regional QAM is a type of and/or component of a regional node used to deliver content to a particular parts of the distribution network, such as subscriber equipment in one or more geographic and/or market areas.

In some situations, the ad selector 106 may apply information provided by the session manager 110 to the selection of an ad. One function of the session manager 110 may be to receive and process a subscriber equipment program/channel request. Toward this end, the session manager 110 may apply information about which QAM and/or other components of a regional node serve particular subscriber equipment, and what programs a regional node is currently receiving and/or passing through to its served region(s).

A QAM and/or other network equipment may be associated with one or more regions, areas, and/or neighborhoods having demographic characteristics. Such demographics may include income distribution information for the residents, family size, viewer age information, dwelling sizes, information about businesses and/or employers for the residents of the neighborhood, and the like. The ad selector 106 may apply such demographics to the selection of an appropriate ad for insertion into one or more program streams.

The ad selector 106 may also or alternatively apply demographic information 117 from sources external to the content delivery provider, such as the U.S. census bureau or third-party information providers.

An example use of an external source would be the ad selector 106 directly querying an external information source while performing the ad selection function. That external source could be available over the Internet or via another communication mechanism, such as satellite. For example, the ad selector may provide a query or otherwise initiate an information search, using an Internet search engine or other location function, to obtain information about a household and/or individual(s) associated with subscriber equipment providing a program/channel request.

The ad selector 106 may obtain identification information for particular endpoint devices (subscriber equipment) providing requests for programs/channels for which ad insertion is to occur. For example, the ad selector 106 may obtain such information from the session manager 110, and may apply the information to locate subscriber information 116 associated with the endpoint devices. The subscriber information 116 may include, for example, the subscriber's interests, purchase history, and past viewing habits. Special attention may be provided to ensuring the subscriber's privacy. For example, if a subscriber is tuned to the fishing channel five hours a day, and fishing equipment is the subject of an ad, the ad there may provide a good match for a program the subscriber is watching, even if the program is not on the fishing channel. In some cases, third party information such as the credit rating of the subscriber may also be applied, although again, special attention should be paid to privacy concerns.

The ad selector 106 may also apply channel information 119 during the ad selection process. An example of channel information 119 is the typical percentage of married couples watching the Discovery Channel™ on weekday evenings. Married couples might be considered as good targets for household appliance or car ads, but they would probably be considered poor targets for purchase of dating club memberships.

The ad selector 106 may apply program information 118 during the ad selection process. For example, a program may be categorized as “foreign travelogue” and may be typically watched by individuals from age thirty-five to fifty-five having an upper-middle class income level. The ad selector 106 may determine that such a program is a poor match for an ad for an air combat video game. However, if the subject of the ad is a game on travel trivia designed for high-end mobile phones, the ad selector 106 may determine that the ad content and the program are a suitable match.

The ad tracker 108 may update ad exposure information 114 with information about exposure for an inserted ad. Exposure information 114 may include information about which ads were included in which programs, on which channels, and at which times. Ad exposure information 114 may also include information about which regions were exposed to which ads, which endpoint devices were tuned to the programs in which the ads were inserted, and so on. In many situations, the client who purchased the ad time may desire to know not only that the purchase conditions were satisfied-(i.e. the ad did run when promised) but also information as to how effective the ad was (i.e., information such as how many active viewers were tuned to the program and/or channel when the ad ran, and/or information about those viewers such as their demographics). The ad tracker 108 and the ad selector 106 may cooperate to capture and record such information.

Description of FIG. 2

FIG. 2 is a block diagram of an embodiment of a system to provide ad selection, distribution, and tracking. FIG. 2 illustrates a switched broadcast network architecture, providing program and/or ad content distribution to both digital endpoint devices (e.g. digital set top boxes), and older, analog endpoint devices (e.g. analog televisions). Both analog and digital representations of program content may be provided concurrently on regional distribution networks serving the endpoint devices.

The system includes the switching network 102, ad selection 106, ad tracking 108, the session manager 110, and the program content 112 and ad content 113. A stream splicer 202 provides insertion of advertising content 113 into program content 112. The splicer 202 may act to provide ad insertion in accordance with digital program insertion (DPI) techniques, by detecting cues in the program content 112, and signaling the ad selector 106. The ad selector 106 instructs one or more video servers 104 to stream ad content 113 at an appropriate time for insertion at ad break location(s) in the program content 112. The splicer 202 replaces content at the ad break(s) in the program content 112 with the ad content 113 streamed from the video server 104. The splicer 202 may also inform the ad selector 106 and/or ad tracking 108 that that the ad was successfully inserted.

The splicer 202 may, in some situations, deliver a digital output stream comprising program content with ads inserted therein to both a digital modulator 208 (e.g. a QAM modulator), and to a digital to analog converter 204 for processing the of the stream into an analog representation prior to analog modulation 206. The analog and digital representations of the stream may be aggregated 210 and communicated to endpoint devices such as a set top box 212.

In some situations, at least some of the endpoint devices may comprise ODAs and/or VNIUs (video network interface units) providing digital to analog conversion and/or analog modulation at or near the subscriber premises. In such situations it may be possible to do without one or more of the network D/As 204, analog modulators 206, and/or combining network.

In most situations, the program stream with inserted advertising may be aggregated with other program and/or ad streams as a digital multicast, prior to modulation in what is known to one skilled in the art as a combining network. The modulator 208 may receive a multicast comprising many programs, and may only pass to region(s) it serves those digital programs that are presently being tuned by endpoint devices in the region. This may act to conserve bandwidth in the regional distribution network, which may-be important in switched broadcast networks where both analog and digital representations of programs are communicated on the regional distribution networks.

Description of FIG. 3

FIG. 3 is a block diagram of an embodiment of a system to provide ad selection, distribution, and tracking.

A head end 302 of the video distribution system may include and/or involve one or more communication interfaces to regional distribution nodes 311 and 312. Two regional nodes 311 312 and a single head end 302 are shown for purposes of discussion; in practice, any practical number may be present.

The head end 302 may include an interface to a high speed switch 310, such as a gigabit-class Ethernet switch. The head end 302 may employ the video server 104 to provide streamed content to the switch 310, and may also provide routing information to direct the content to the appropriate regional node(s). There may be other communications interfaces (not shown) between the system components, such as a communication interface between the switching network 102 of the head end 302 and the switch 310.

The regional distribution nodes 312 and 313 each serve content through a regional distribution plant to various endpoint devices 302-307 typically located on or near subscriber premises. To accomplish this, they may at times communicate information such as a program/channel request generated by subscriber equipment 302-307 upstream through the switch 310 to the session manager application 110, which may service the request.

The system may include logic to select one or more ads for insertion into streamed video content at least in part according to information about which of the regional distribution nodes 312 313 are and/or will be distributing content into which the one or more regional ads are to be embedded.

Advertising Selection

The system may include and/or involve at least one video server 104, and logic 106 to select one or more ads for streaming at one or more ad insertion points by the at least one video server 104, the one or more ads selected at least in part according to information about which of one or more regional modulators 208 are passing and/or will be passing content with which the one or more ads are associated.

The logic 106 to select one or more ads may include and/or involve logic to select one or more ads according to demographic information for one or more geographic areas served by the one or more regional modulators. Such demographic information could, for example, include one or more of information about the average household size for the neighborhoods in the geographic area, the age distribution of households within the area, the percent of families with children in the K-12 system, the distribution of income for the neighborhoods within the area, and/or the type of major employers most adults living in the area work at. The system may include logic 106 to select one or more ads at least in part according to a number of subscribers in an area or areas served by the one or more regional modulators 208. The system may include logic 106 to select one or more ads at least in part according to one or more characteristics of homes and/or businesses in an area or areas served by the one or more regional modulators 208.

The system may include logic 106 to select one or more ads at least in part according to viewer habits for an area or areas served by one or more regional modulators 208. This may include logic 106 to select one or more ads at least in part according to customer viewing behavior and/or video-on-demand purchases and/or consumption habits of viewers in an area or areas served by the one or more regional modulators 208. The logic 106 to select one or more ads at least in part according to viewer habits for an area or areas served by the one or more regional modulators 208 may include and/or involve logic to select one or more ads at least in part according to one or more of viewer program preferences, times when viewers are likely to be viewing, and/or how often and under what circumstances viewers are likely to switch programs. As an example of use of viewer program preferences, if it is known a certain household watches gardening programs at least eight hours a week, an ad for an area nursery selling plants and garden supplies may be considered a good match for that particular household.

The logic 106 to select one or more ads at least in part according to one or more characteristics of homes and/or businesses in an-area or areas served by the one or more regional modulators 208 may include and/or involve logic to select one or more ads at least in part according to one or more of income levels of households in the area or areas, size and/or age and/or price of homes in the area or areas, age and/or ethnic distribution of residents of the area or areas, and/or education levels for residents of the area or areas.

The system may include and/or involve logic 106 to select one or more ads for streaming by the at least one video server 104, the one or more ads selected at least in part according to profile information for households receiving content with which the one or more ads are to be associated, the at least one video server 104 streaming the one or more ads to one or more regional modulators 208 serving the households.

The system may include and/or involve logic 106 to receive, in conjunction with a program selection, from one or more endpoint devices 302-307 (e.g. set top boxes), a device identifier, and an identifier of a regional distribution node (e.g. 311 or 312) or component thereof with which the endpoint device is associated, and to associate likely viewer information with the regional distribution node 311 or 312, and/or the device identifier, and to select one or more ads to include with a viewer experience of content selected by the program selection, the ads selected at least in part according to the likely viewer information.

The system may include logic 106 to select one or more ads at least in part according to one or more ad schedules. The system may include logic 106 to select one or more ads at least in part according to ads to which a region or regions served by the one or more digital modulators 208 were previously exposed. The system may include logic 106 to select one or more ads according to at least one of a channel viewing profile, program viewing profile or ad exposure profile for a region or regions served by the one or more regional modulators 208.

The system may include logic 106 to not select an ad, i.e., to skip streaming one or more ads specified by one or more ad schedules, when the information about which regional modulators 208 are passing the content indicates that inadequate ad exposure would result from streaming the ad. An example of inadequate exposure might be when the ad selector 106 determines and/or identifies that only three families are tuned to a channel, but the exposure rules for that ad require at least thirty families to be tuned to the channel for ad selection.

The system may include logic 106 to select one or more ads in accordance with rules specified in one or more ad schedules. The system may include logic 106 to modify the one or more ad schedules according to ad selections and/or other dynamic conditions.

The logic 106 to select one or more ads at least in part according to ads to which a region or regions served by the one or more digital modulators 208 were previously exposed may include and/or involve logic to select one or more ads at least in part according to ads previously associated with the content for a region or regions served by the one or more regional modulators 208, and/or logic to reference one or more ad exposure records for or including a region or regions served by the regional modulators 208.

Other Factors in Advertising Selection

The system may include and/or involve logic 106 to select one or more ads to stream at least in part according to characteristics of the content with which to associate the ads. The logic 106 to select one or more ads to stream at least in part according to characteristics of the content with which to associate the ads may include and/or involve logic to select one or more ads at least in part according to at least one of a category, genre, actor, theme, plot, target audience, or other attribute of the content.

The system may include and/or involve logic 106 to select one or more ads to stream at least in part according to the demographic profile of the channel on which the ad would play. For example, a channel with a demographic profile of 75% young males between the ages of sixteen and thirty might be considered an attractive place to advertise a used car business. A channel with a demographic profile of 50% retired people in the hours between 6 pm and 12 pm might be considered an attractive place to run ads for recreational vehicles.

The system may include and/or involve logic 106 to select one or more advertisements at least in part according to one or more of a time of day, a day of the week, a season, or a date.

The system may include and/or involve logic 106 to analyze, weigh, and/or rank two or more of the various factors applied to select ad candidates in order to rank the ad candidates and/or select the most attractive candidate. For example, an ad advertising a used car lot may be a good fit from the perspective of channel demographics (mostly young males) and neighborhood demographics (working class, the target buyers for used cars) but a poor fit on program content (a gardening show). A second ad (advertising an area nursery) may be a good fit on program content but a poor fit on neighborhood demographics (mostly apartment buildings).

Advertising Exposure Tracking

The system may include and/or involve logic 108 to update one or more ad exposure records (e.g. one or more ad logs) at least in part according to information about which of one or more regional modulators 208 are passing, will be passing, and/or have passed content with which the one or more ads are associated.

The system may include and/or involve logic 108 to skip recording an ad exposure indication when the information about the regional modulators 208 is applied to indicate that insufficient exposure resulted for the one or more ads selected for streaming.

The system may include and/or involve logic 108 to record ad exposure information for the selected one or more ads that includes an indication of a region or regions served by the one or more regional modulators 208 which passed the content with which the one or more ads are associated.

The system may include and/or involve logic 108 to record ad exposure information including information indicating which regional distribution nodes 312 311, and/or component or components thereof, is distributing, will be distributing, and/or did distribute the content into which the one or more regional ads are to be embedded.

The system may include and/or involve logic 108 to record any of the factors used by the ad selector to select one or more ads for insertion.

Obtaining Information Used in Ad Selection Analysis

The system may obtain the information it uses in ad selection from internal sources, such as information on regional viewing characteristics, and/or which subscribers are currently watching a particular program and/or channel. This information may be obtained, for example, by correlating information about which set top boxes are tuned to which programs and/or channels with information on which subscribers use those set top boxes. In some situations such information may be obtained from set top box program/channel tuning requests to the session manager 110, where an identification is made of one or more regional nodes 311 312 and/or components thereof (such as an associated digital modulator 208) serving the set top boxes.

The system may also obtain information used in ad selection from third party sources, such as the U.S. census bureau or a credit bureau, and/or via Internet queries.

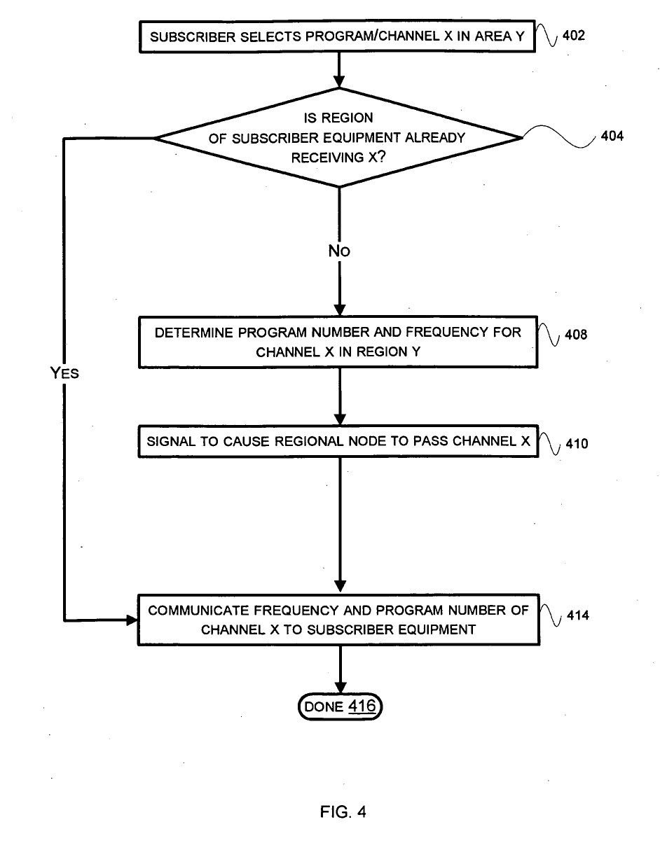

Description of FIG. 4

FIG. 4 is a flow chart of an embodiment of a process of content selection and distribution.

A session manager application may interact with various components of the content distribution system, at a cable head end and possibly through the distribution network, to service endpoint device program/channel requests. Information obtained by the session manager may be retained in an information store and provided for use during ad selection. Examples of such information include which elements of the distribution network, such as which QAMs, are receiving and/or passing which programs and/or channels, and/or which endpoint devices are tuned to which programs/channels.

Referring to FIG. 4, at 402 user equipment selects channel X from an interactive programming guide provided to an area (region) Y comprising the user equipment. At 404 a session manager application and/or other system component determines if a regional modulator and/or regional node, such as a QAM or node comprising the QAM, for area Y is already receiving (and passing) the channel X. If the node/component serving area Y is already passing channel X, at 414 the session manager communicates the frequency and program number for channel X to the subscriber equipment.

If the node/component serving area Y is not already passing channel X, at 406 a regional node and/or component thereof is selected to deliver channel X to area Y.

At 408 a frequency and program number for tuning channel X in area Y are identified and assigned to the program by the modulator and/or by another system component.

At 410, possibly in conjunction with verifying the availability of bandwidth for the program/channel content on the regional distribution plant, the selected regional node/component is signaled to receive and/or pass channel X. For example, if the regional node/component is already receiving a digital multicast that includes the program, the node/component is signaled to pass the program to the regional distribution plant that it serves. Otherwise, the program/channel content may be provided to the regional node/component (if not already provided thereto), and the regional node/component signaled to pass the provided program stream.

At 414, as described before, the subscriber equipment is informed of the tuning frequency and program number for X to use to accomplish the tuning request. At 416 the process concludes.

The techniques described herein and/or variants thereof may apply to situations employing other endpoint devices (such as televisions with integrated digital cable tuners). This is true in general throughout this description.

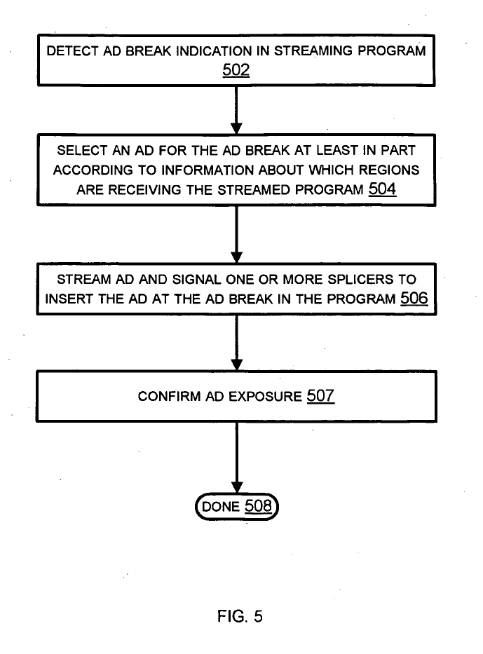

Description of FIG. 5

FIG. 5 is a flow chart of an embodiment of a process of ad selection.

At 502 an ad break is detected in a program stream. The ad break may be detected by a splicer for the stream, or by a video server for the stream, or by another system component, depending upon the implementation. In response, the detecting component may signal an ad selector to initiate the ad selection process.

At 504 the ad selector may access and apply various information to select an ad to insert at the ad break. The ad selector may interact with a session manager and/or other system components to identify an area or areas, and/or subscriber or subscribers, receiving the program. Ad candidates may be obtained from one or more ad schedules, and/or via other rules or conditions. Based on an analysis of various factors, such as those discussed previously, none, one, or multiple ads may be selected for insertion.

At 506 a selected ad is streamed by the video server to the splicer, which is signaled to insert the ad at the proper point in the program stream. At 507 the splicer confirms that an ad exposure took place. At 508 the process concludes.

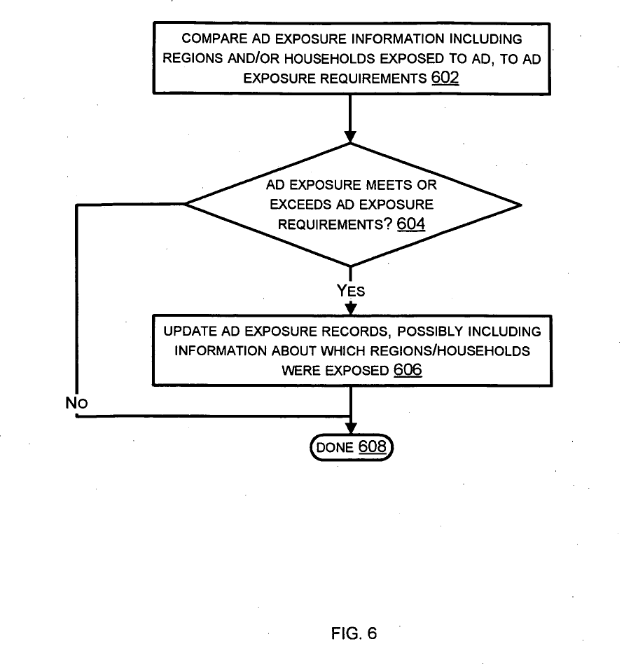

FIG. 6 is a flow chart of an embodiment of a process of ad tracking.

At 602 a comparison is made (for example, by an ad tracker) of which regions and/or households (e.g. subscribers) were actually exposed to an inserted ad, to the ad exposure requirements. As previously described, information about regions/subscribers exposed to an ad may be obtained from information about which regional nodes and/or components thereof actually passed the program stream including the ad, and/or via interaction with a session manager with information about endpoint device tuning requests.

At 604, if the comparison results in a determination that the ad exposure was effective in meeting the ad exposure requirements, ad exposure records are modified or inserted for the ad exposure. Otherwise, the ad exposure records may not be modified, even though the ad was selected, inserted, and distributed with the program stream. The process concludes at 608. The updated ad exposure records may include some or all of the information used by the ad selector to select the ad, such as information about which areas and/or households were actually exposed to the ad.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer, determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A system comprising:
at least one video server; and
logic to select one or more ads for streaming by the at least one video server, the one or more ads selected at least in part according to information about which of one or more regional modulators are passing and/or will be passing content with which the one or more ads are to be associated.

2. The system of claim 1, wherein the logic to select one or more ads for streaming by the at least one video server further comprises:
logic to select one or more ads according to demographic information for one or more geographic areas served by the one or more regional modulators.

3. The system of claim 1, wherein the logic to select one or more ads for streaming by the at least one video server further comprises:
logic to select one or more ads at least in part according to a number of subscribers in an area or areas served by the one or more regional modulators.

4. The system of claim 1, wherein the logic to select one or more ads for streaming by the at least one video server further comprises:
logic to select one or more ads at least in part according to one or more characteristics of homes and/or businesses in an area or areas served by the one or more regional modulators.

5. The system of claim 4, wherein the logic to select one or more ads at least in part according to one or more characteristics of homes and/or businesses in an area or areas served by the one or more regional modulators further comprises:
logic to select one or more ads at least in part according to one or more of income levels of households in the area or areas, size and/or age and/or price of homes in the area or areas, age and/or ethnic distribution of residents of the area or areas, or education levels for residents of the area or areas.

6. The system of claim 1, wherein the logic to select one or more ads for streaming by the at least one video server further comprises:
logic to select one or more ads at least in part according to viewer habits for an area or areas served by the regional modulator.

7. The system of claim 6, wherein the logic to select one or more ads at least in part according to viewer habits for an area or areas served by the regional modulator further comprises:
logic to select one or more ads at least in part according to one or more of viewer program preferences, times when viewers are likely to be viewing, or how often and under what circumstances viewers are likely to switch programs.

8. The system of claim 1, wherein the logic to select one or more ads for streaming by the at least one video server further comprises:
logic to select one or more ads at least in part according to pay-per-view purchases and/or video-on-demand purchases for one or more customers of an area or areas by the one or more regional modulators.

9. The system of claim 1, wherein the logic to select one or more ads for streaming by the at least one video server further comprises:
logic to select one or more ads at least in part according to consumption habits of viewers in an area or areas served by the one or more regional modulators.

10. The system of claim 1, wherein the logic to select one or more ads for streaming by the at least one video server further comprises:
logic to select one or more ads at least in part according to one or more ad schedules.

11. The system of claim 1, wherein the logic to select one or more ads for streaming by the at least one video server further comprises:
logic to select one or more ads at least in part according to ads to which a region or regions served by the one or more digital modulators were previously exposed.

12. The system of claim 11, wherein the logic to select one or more ads at least in part according to ads to which a region or regions served by the one or more digital modulators were previously exposed further comprises:
logic to select one or more ads at least in part according to ads previously associated with the content for a region or regions served by the one or more regional modulators.

13. The system of claim 11, wherein the logic to select one or more ads at least in part according to ads to which a region or regions served by the one or more digital modulators were previously exposed further comprises:
logic to reference one or more ad exposure records for or including a region or regions served by the regional modulators.

14. The system of claim 1, wherein the logic to select one or more ads for streaming by the at least one video server further comprises:
logic to select one or more ads according to at least one of a program viewing profile or ad exposure profile for a region or regions served by the one or more regional modulators.

15. The system of claim 1, wherein the logic to select one or more ads for streaming by the at least one video server further comprises:
logic to skip streaming one or more ads specified by one or more ad schedules, when the information about which regional modulators are passing the content indicates that inadequate ad exposure would result from streaming the ad.

16. The system of claim 1, wherein the logic to select one or more ads for streaming by the at least one video server further comprises:
logic to select one or more ads in accordance with rules specified in one or more ad schedules.

17. The system of claim 1, further comprising:
logic to update one or more ad exposure records at least in part according to information about which of one or more regional modulators are passing, will be passing, and/or passed content with which the one or more ads are associated.

18. The system of claim 1, further comprising:
logic to select one or more ads for streaming by the at least one video server, the one or more ads selected at least in part according to profile information for households receiving content with which the one or more ads are to be associated, the video server streaming the one or more ads to one or more regional modulators serving the households.

19. The system of claim 1, further comprising:
logic to select one or more ads to stream at least in part according to characteristics of the content with which to associate the ads.

20. The system of claim 19, wherein the logic to select one or more ads to stream at least in part according to characteristics of the content with which to associate the ads further comprises:
logic to select one or more ads at least in part according to at least one of a category, genre, actor, theme, plot, target audience, or other attribute of the content.

21. The system of claim 1, further comprising:
logic to select one or more advertisements at least in part according to one or more of a time of day, a day of the week, a season, or a date.

22. The system of claim 1, further comprising:
logic to skip recording an ad exposure indication when the information about the regional modulators is applied to indicate that insufficient exposure resulted for the one or more ads selected for streaming.

23. The system of claim 1, further comprising:
recording ad exposure information for the selected one or more ads that includes an indication of a region or regions served by the one or more regional modulators which passed the content with which the one or more ads are associated.

24. An ad selector in a content distribution system comprising:
one or more communication interfaces to regional distribution nodes; and
logic to select one or more ads for insertion into streamed video content at least in part according to information about which of the regional distribution nodes are and/or will be distributing content into which the one or more regional ads are to be embedded.

25. The ad selector in a content distribution system of claim 24, further comprising:
logic to record ad exposure information including information indicating which of the regional distribution nodes is distributing, will be distributing, and/or did distribute the content into which the one or more regional ads are to be embedded.

26. The ad selector in a content distribution system of claim 24, further comprising:
logic to receive from a set top box, in conjunction with a program selection, a set top box identifier, and an identifier of a regional distribution node with which the set top box is associated, and to associate likely viewer information with the regional distribution node and/or the set top box identifier, and to select one or more ads to include with a viewer experience of content selected by the program selection, the ads selected at least in part according to the likely viewer information.

27. The ad selector in a content distribution system of claim 24, further comprising:
logic to select one or more ads to stream at least in part according to characteristics of the content with which to associate the ads.

28. The ad selector in a content distribution system of claim 27, wherein the logic to select one or more ads to stream at least in part according to characteristics of the content with which to associate the ads further comprises:
logic to select one or more ads at least in part according to at least one of a category, genre, actor, theme, plot, target audience, or other attribute of the content.

29. The ad selector in a content distribution system of claim 24, further comprising:
logic to select one or more advertisements at least in part according to one or more of a time of day, a day of the week, a season, or a date.
